(19) United States
(12) Patent Application Publication
(10) Pub. No.: US 2007/0108250 A1
(43) Pub. Date: May 17, 2007

(54) Fastening element feeding device for a hand-held power drive-in tool

(75) Inventors: Walter Odoni, Planken (CH); Ulrich Schiestl, Feldkirch (AT); Hans Gschwend, Buchs (CH)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/600,249

(22) Filed: Nov. 14, 2006

(30) Foreign Application Priority Data
Nov. 16, 2005 (DE) 10 2005 000 157.2

(51) Int. Cl. B25B 23/00; B25B 17/00; B25C 3/00; B25C 5/00

(52) U.S. Cl. 227/107; 81/57.37

(57) ABSTRACT

A hand-held power drive-in tool, includes a drive-in channel (12) having a receptacle (18) for receiving fastening elements (41) and an electrically driven fastening element feeding device (10) having a transporting device (30) for transporting the fastening elements (41) stored in a magazine into the receptacle (18).

### BACKGROUND OF THE INVENTION

1. Field of the Invention

The present invention relates to a hand-held power drive-in tool including a drive-in channel having a receptacle for receiving fastening elements stored in a magazine, and in particular, to a fastening element feeding device for such a drive-in tool and having a transporting device for transporting the fastening elements into the receptacle.

2. Description of the Prior Art

Fastening element feeding devices for hand-held power drive-in tool such as, e.g., screwdriving tools or setting tools serve for feeding fastening elements such as, e.g., screws, nails, bolts and the like into a drive-in channel of a drive-in tool in which a drive-in working tool is displaceable. The fastening elements are stored in a magazine attached to the drive-in tool, with the fastening elements being lined up parallel to each other on an elongate carrier material (e.g., strip, wire, or plastic strip) and forming a rigid or flexible string-shaped connection. With a flexible strip, the strip can be coiled-up to form a roll so that a so-called coil magazine is provided on the drive-in tool.

German Utility Model DE 203 09 492 U1 discloses a screwdriving tool with a screw feeding device and which has a holder provided on a housing flange of the screw-driving tool. A screw guide is arranged on the holder with a possibility of displacement relative thereto, with its end, which faces in the operational direction of the drive-in tool, being placed against the workpiece. On the screw guide, a swivel disc is supported on which a pawl is provided. The pawl has an arm that extends from the swivel disc and carries at its opposite end a fixing pin. The pin extends through a first arc-shaped opening of a link of a drive block and extends through a guideway in the holder. When the screw guide is pressed into the holder upon the screwdriving tool being pressed against a workpiece, the fixing pin is displaced along the guideway, with the pawl being pivoted by the arc-shaped opening. This causes the displacement of screws through the screw guide and toward the screwdriver.

The drawback of the above-described solution consists in that the operational energy for the transportation of the screw strip must be provided by the user, which adversely effects the user's comfort during the operation. Another drawback consists in that the screws should be spaced from each other on the screw strip by the same distance because the transportation path over the swivel disc is always the same. Therefore, only fastening elements having a certain diameter can be used.

U.S. Pat. No. 6,422,447 discloses a fastening device for driving a fastening element in a workpiece that includes a drive-in mechanism located in the housing. The drive-in mechanism includes a striker for the fastening element. The fastening device has a nose assembly placeable on the workpiece and displaceable relative to the guide of the fastening device. A transportation device feed a fastening element from a magazine with fastening elements to the nose assembly before the fastening element is driven by the striker into the workpiece. The transportation device uses, directly or indirectly, the press-on energy with which the user presses the fastening device against the workpiece.

The drawback of the fastening device of the U.S. patent consists in that the operational energy for transporting a fastening element is again provided by the user, which creates discomfort for the user. Here again, the fastening elements must be spaced from each other by the same distance in the magazine strip because the displacement path, over which a fastening element is transported is always the same. Therefore, only fastening elements having a certain diameter can be used.

Accordingly, an object of the present invention is to provide a hand-held power drive-in tool with a fastening element feeding device in which the above-discussed drawbacks of the known drive-in tools are eliminated and which insures a wide flexibility in its use.

### SUMMARY OF THE INVENTION

This and other objects of the present invention, which will become apparent hereinafter, are achieved by electrically driving the transporting device of the fastening element feeding device. As a result, the energy for transporting fastening elements need not be provided by the user but can be supplied in very simple manner from a battery, an accumulator, or a network. In most of the drive-in tools, such an electrical power source is already available because a drive-in power tool is already driven by an electrical main drive. Therefore, no additional costs are involved for providing the electrical energy. A further advantage consists in the flexibility of the electrical drive that can be provided at different points along the length of the displacement or transportation path and, therefore, permit transportation of fastening elements having different diameters.

According to an advantageous embodiment of the present invention, the electric drive of the transportation device is located in the tool housing and can also be used for driving the drive-in tool.

Advantageously, the electrical drive of the transporting device is controlled by an electronic control unit, which provides for a timely and position-precise transportation of the fastening elements.

Advantageously, there is provided means for detecting an object in the receptacle of the drive-in channel, which is connected to the control unit. This measure permits to communicate to the control unit a signal that a fastening element, which is fed by the transporting device, has been received in the receptacle, so that the control unit can turn off the electric drive of the transportation device. Thereby, the control unit can also recognize when the receptacle is empty and is ready to receive another fastening element for a new drive-in process. The detecting means also permits to recognize failed positions of the drive-in working tool. E.g., the detecting means permits to determine when a driving piston of a setting tool has not completely returned in is initial position after completion of a drive-in process and, therefore, blocks the receiving space. In this case, the control unit would block the displacement of a fastening element by the transporting device until the failed position of the drive-in working tool is eliminated, and the receptacle becomes free.

Instead of or in addition to the detection means, means, e.g., for determining the distance between two adjacent fastening elements in the magazine can be also provided, which also would be connected with the control unit. Based on the data communicated by this means, the control unit can calculate the necessary displacement of the fastening element by the transporting device and turn off automatically the electric drive of the transporting device after a fastening element has been displaced, without receiving a turn-off signal of a detecting device.

According to a technically low-cost solution, the detecting means is formed as a capacity sensor. Alternatively, other switching means or sensors can be used such as, e.g., photosensors or electromechanical switches.

Advantageously, the electric drive is formed as a servo motor that can be driven in different directions and that is particularly suitable to be controlled by the electronic control unit, and that further provides for a rapid sequence of alternative displacement steps. Of course, other electrical drives such as, e.g., unidirectional motors, solenoids, or the like can be used.

Advantageously, the servo motor is connected with a transporting member elastically pivotable in a direction opposite a displacement direction of the transporting device. In this way, the transportation displacement of the electric drive can be transmitted to the magazine strip with fastening elements in a technically low-cost manner. A transporting member which is, e.g., formed as a claw, can easily engage the magazine strip or a separate fastening element. Because of the pivotability of the transporting member in the direction opposite the transportation direction of the transporting device, the transporting member can be easily displaced by the electric drive in the opposite direction past the magazine strip for engaging the following fastening element to subsequently transport it.

Alternatively, the transporting member can be formed, e.g., as a transporting or split gear driven by an electric drive formed as a servo drive.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS:

The drawings show:

FIG. 1 a side partially cross-sectional view of a hand-held drive-in tool formed as a setting tool and equipped with a fastening element feeding device according to the present invention;

FIG. 2 a cross-sectional view of the fastening element feeding device shown in FIG. 1 along line II-II in FIG. 1;

FIG. 3 a cross-sectional view of the fastening element feeding device shown in FIG. 2 at an increased, in comparison with FIG. 2, scale; and

FIG. 4 a cross-sectional view of a hand-held drive-in tool formed as a screwdriving tool and equipped with a fastening element feeding device according to the present invention.

### DETAILED DESCRIPTION OF THE PREFERRED EMBODIMENTS

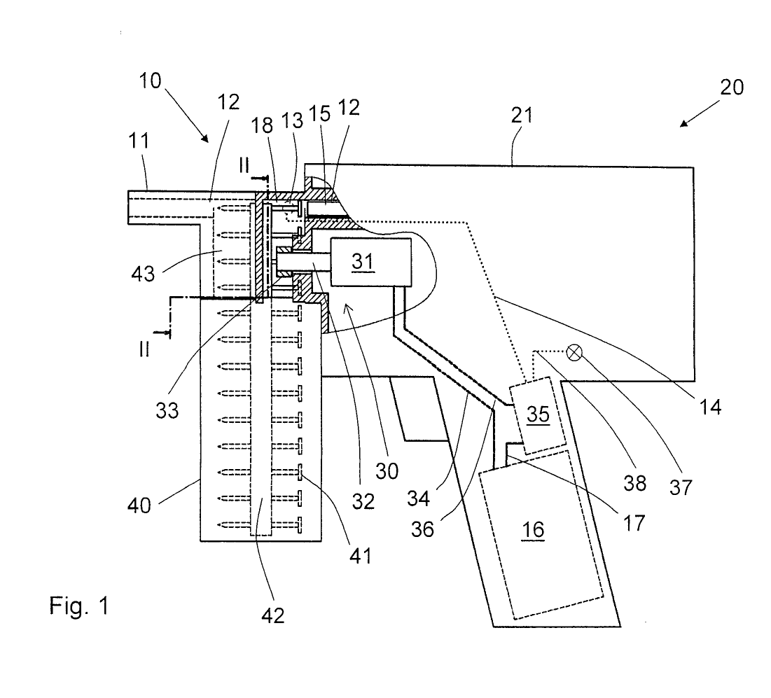

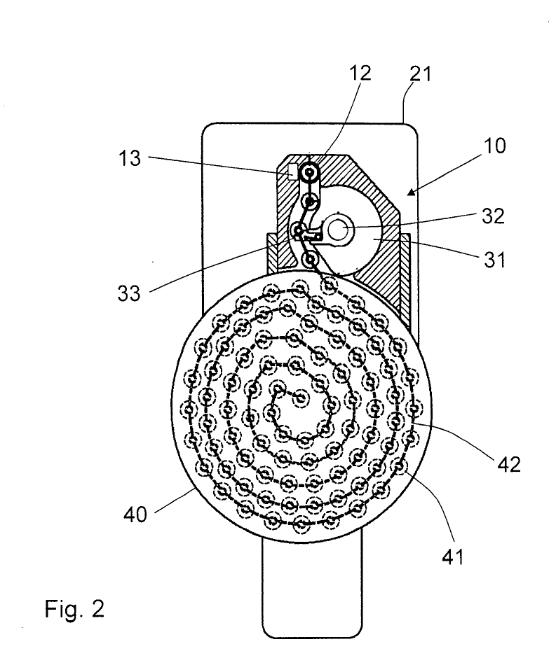

FIGS. 1 through 3 shows a hand-held power drive-in tool designated generally with reference numeral 20 which is equipped with a fastening element feeding device according to the present invention and designated generally with a reference numeral 10. The drive-in tool 20 includes a housing 21 in which there is arranged a drive of the drive-in tool, not shown in the drawing. The drive-in tool 20, which is shown in FIGS. 1-3, is formed as a setting tool with which a fastening element 41 is driven in a workpiece with a drive-in working tool 15 that is formed as a driving ram or a driving piston. The drive-in piston can be driven in per se known manner, e.g., by expandable gases (combustion gases, compressed air, etc.) or electrically, e.g., by an electrically driven flywheel. The drive-in tool 1 is displaceable in a drive-in channel 12 having a receptacle (118) for the fastening element 41.

On a head portion 11 of the drive-in tool 20, there is arranged a magazine 40 formed as a coil magazine which forms part of the fastening element feeding device 10 and which carries fastening elements 41 in form of nails arranged in a magazine strip 42.

The fastening element feeding device 10 forms an integral part of the drive in tool 20. However, the fastening element feeding device 10 can also be formed as a separate unit and replaceably secured on a flange of the drive-in tool 20, e.g., with a coupling section.

The transporting device 30 of the fastening element feeding device 10 is located adjacent to the magazine 40 and is designed for displacing the magazine strip 42. The transporting device 30 includes an electric drive 31 which is formed as a servo mechanism having a drive shaft 32 on which a transporting member 33 is arranged. The transporting member 33 extends into a guide space 43 of the magazine 40 for the magazine strip 42. The transporting member 33 is formed as an elastically pivotable pawl which is held by a spring 39 in a position in which it projects radially a way from the shaft 32 of the drive 41.

In the region of the receptacle 18, there is arranged object detection means 13 for detecting objects such as a fastening element 41 or the drive-in working tool 15. The object detection means 13 is formed as a capacity sensor that is connected by a first conductor 14 with a control unit 35. The detection means 13 detects presence or absence of a fastening element 41 or the drive-in working tool 15 in the receptacle 18 and communicates a corresponding signal to the control unit 35 over the first conductor 14. The control unit 35 and other electrical components, which are associated with the control unit 35, are supplied with electrical energy from a voltage source 16 such as, e.g., at least one battery or at least one accumulator, over a second conductor 17. The electric drive 31 is supplied with electrical energy from the voltage source 16 via a third conductor 34. A fourth conductor 36 connects the control unit 35 with the electric drive 31 for controlling the same. The drive-in tool 20 is further equipped with optical and/or sound signal means 37 that is are connected with the control unit 35 by a fifth conductor 38.

In the embodiment of the drive-in tool 20 shown in FIGS. 1-3, the electric drive 31, the voltage source 16, and the control unit 35 are all arranged in the housing 21 of the drive-in tool 20. It is, however, possible to arrange them directly in an independent fastening element feeding device 10 such as e.g., a magazine unit mountable on a drive-in tool.

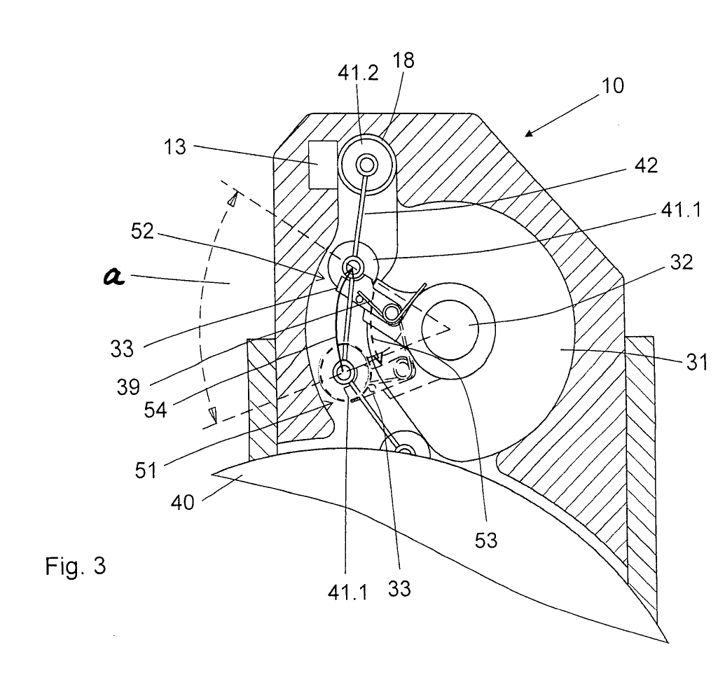

The transportation of the fastening element 41 with the transporting device 30 in the fastening element feeding device 10 takes place after a fastening element 41 has been driven in a workpiece (not shown in the drawings. The drive-in working tool 15 is then displaced from the receptacle 18 which is detected by the detection means 13, and a corresponding signal is transmitted to the control unit 35 over the first conductor 14. As shown in FIG. 3, the electric drive 31 displaces the transporting member 33, under control of the control unit 35, in the direction of arrow 53, shown with dash lines, in a first position 51, and the transporting member 33 pivots past a fastening element 41.1 against the biasing force of the spring 39. After reversal of the drive direction of the electric drive 31 by the control unit 35, the transporting member 33 engages the fastening element 41.1 from behind, and the fastening element 41.1 is transported by the transporting member 33 in the direction of arrow 54 over a path shown in FIG. 3 by angle “a,” with the transporting member 33 being displaced to a second position 52. In the second position 52 of the transporting member 33, a new fastening element 41.2 is located in the receptacle 18 of the drive-in channel 12.

The presence of the fastening element 41.2 in the receptacle 18 is detected by the detection means 13 and communicated to the control unit 35. A further drive-in process can be effected with the drive-in tool 20. When there is no fastening element 41 to be transported by the transporting member 33, the transporting member 33 idles, in response to which, the control unit 35 actuates the signal means 37 that generates an optical and/or acoustic signal. Another signal can be generated by the signal means 37, under control of the control unit 35, when the receptacle 18 is not empty after a completion of a drive-in process, e.g., when the drive-in working tool 15 is not withdrawn, as required by a proper operation of the drive-in tool 20.

The angle “a” that defines the transportation path, can have different values which depend on the distance of the fastening elements 41 to each other and/or on their diameter.

Alternatively or in addition to the detection means 13, there can be provided a detection device that senses the distance between two fastening elements 41 in the magazine strip 42 and which is transmitted to the control unit 35 which, based on these data, predetermined the transportation width.

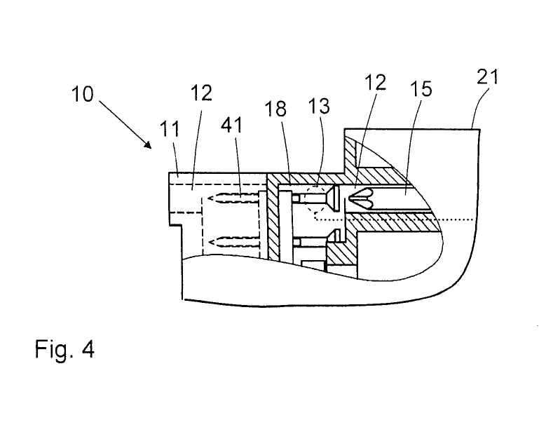

The fastening element feeding device 10, which is shown in FIG. 4, is mounted on a drive-in tool 20 formed as a screw-driving tool and differs from that described above only in that the drive-in working tool 15 displaceable in the drive-in channel 12 is formed as a screwdriver.

Though the present invention was shown and described with references to the preferred embodiments, such are merely illustrative of the present invention and are not to be construed as limitations thereof and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. A hand-held power drive-in tool, comprising a drive-in channel (12) having a receptacle (18) for receiving fastening elements (41); and a fastening element feeding device (10) having a transporting device (30) for transporting the fastening elements (41) stored in a magazine into the receptacle (18), and electrical means for driving the transporting device (30).

2. A hand-held power drive-in tool according to claim 1, wherein the driving electrical means comprises an electric drive (31).

3. A hand-held power drive-in tool according to claim 2, wherein the electric drive (31) is located in a housing (21) of the drive-in tool (20) which houses the drive of the drive-in tool (20) itself.

4. A hand-held power drive-in tool according to claim 2, wherein the fastening element feeding device (10) comprises a control unit (35) for controlling operation of the electric drive (31) of the transportating device (30).

5. A hand-held power drive-in tool according to claim 4, further comprising means (13) for detecting presence of an object in the receptacle (18) of the drive-in channel (12) and connectable with the control unit (35).

6. A hand-held power drive-in tool according to claim 4, wherein the detecting means (13) is formed as a capacity sensor.

7. A hand-held power drive-in tool according to claim 2, wherein the electric drive (31) is formed as a servo motor.

8. A hand-held power drive-in tool according to claim 2, wherein the transporting device (30) comprises a transporting member (30) elastically pivotable in a direction opposite a displacement direction of the transporting device, and wherein the electric drive (31) is connected with the transporting member (33).

9. A fastening element feeding device for a hand-held power drive-in tool having a drive-in channel (12) with a receptacle (18), the fastening element feeding device (10) comprising; a transporting device (30) for transporting fastening elements (41) stored in a magazine into the receptacle (18); and electrical means for driving the transporting device (30).
